(19) United States
(12) Patent Application Publication
(10) Pub. No.: US 2023/0113796 A1
(43) Pub. Date: Apr. 13, 2023

(54) WAITING TIME ESTIMATION DEVICE, WAITING TIME ANNOUNCEMENT SYSTEM, WAITING TIME ESTIMATION METHOD, AND PROGRAM STORAGE MEDIUM

(71) Applicant: NEC Corporation, Minato-ku, Tokyo (JP)

(72) Inventors: Kazuki SEKO, Tokyo (JP); Takeshi KOJIMA, Tokyo (JP); Makoto KATAOKA, Tokyo (JP); Toshiro YAMAMOTO, Tokyo (JP)

(73) Assignee: NEC Corporation, Minato-ku, Tokyo (JP)

(21) Appl. No.: 17/801,847

(22) PCT Filed: Mar. 18, 2020
(86) PCT No.: PCT/JP2020/011873

§ 371 Date: Aug. 24, 2022

(51) Int. Cl. G06V 20/52

(52) U.S. Cl. CPC G06V 20/52

(57) ABSTRACT

A waiting time estimation device includes an acquisition unit, an estimation unit and an output unit. From captured images of queuing-up people, the acquisition unit acquires, as attribute information, at least one piece of information out of: the behaviors of the queuing-up people; the types of the belongings of the queuing-up people; the facial expressions of the queuing-up people; and information as to whether or not any groups have been formed in the queuing-up people. The estimation unit estimates, as the waiting time in the queuing-up case, a time that is obtained by modifying a standard waiting time in the queuing-up case through the use of a modification time having been set on the basis of the attribute information. The output unit outputs the estimated waiting time of the queue toward an announcement device that announces the waiting time.

### TECHNICAL FIELD

The present invention relates to a technology for estimating a waiting time of a queue.

### BACKGROUND ART

A long queue may lead to dissatisfaction of users. Therefore, measures are taken to alleviate users' dissatisfaction by estimating waiting times of queues and presenting information regarding the estimated waiting times to the users.

PTL 1 discloses a technology for calculating waiting times of customers lined up in a queue for an automated teller machine based on sexes and ages of the waiting customers. PTL 2 discloses a technology of calculating the length of a queue and calculating a waiting time of the queue based on the calculated length of the queue.

### CITATION LIST

### Patent Literature

[PTL 1] JP 2019-133372 A
[PTL 2] JP 2007-317052 A

### SUMMARY OF INVENTION

### Technical Problem

In the technology disclosed in PTL 1, transaction times required for customers to operate an automated teller machine are calculated according to combinations of ages and sexes of the customers lined up in a queue and transaction times of the customers lined up in the queue are summed up to calculate waiting times in the queue in some cases.

However, there are people who take longer times and people who takes shorter times to operate an automated teller machine, and thus the transaction times are not necessarily the same, and the range of times assumed as the transaction times of people of the same age and sex is wide. Therefore, there is concern of a difference between a waiting time of a queue calculated using the technology disclosed in PTL 1 and an actual waiting time of the queue being large. In PTL 2, similarly, even when the lengths of queues are the same, actual waiting times of the queues are not necessarily the same, and there is concern of a difference between calculated waiting times of the queue and the actual waiting times of the queue being large.

The present invention has been finalized to solve the foregoing problems. That is, a main objective of the present invention is to provide a technology for improving estimation accuracy of a waiting time of a queue.

### Solution to Problem

In order to achieve the foregoing objective, according to an aspect of the present invention, a waiting time estimation device includes:

an acquisition unit configured to acquire, as attribute information, at least one type of information among content of behaviors, a type of a belonging, an expression, and information indicating whether a group is formed that are related to people lined up in a queue, from a captured image in which the people lined up in the queue are imaged;

an estimation unit configured to estimate a time obtained by adjusting a standard waiting time in a case of the lining-up in the queue by using an adjustment time set based on the attribute information as a waiting time in the case of the lining-up in the queue; and

an output unit configured to output the estimated waiting time of the queue to an announcement device that announces the waiting time.

According to another aspect of the present invention, a waiting time announcement system includes:

the above-described waiting time estimation device;

an imaging device configured to provide the captured image to the waiting time estimation device; and

an announcement device configured to announce the waiting time estimated by the waiting time estimation device.

According to still another aspect of the present invention, a waiting time estimation method includes:

acquiring, as attribute information, at least one type of information among content of behaviors, a type of a belonging, an expression, and information indicating whether a group is formed that are related to people lined up in a queue, from a captured image in which the people lined up in the queue are imaged;

estimating a time obtained by adjusting a standard waiting time in a case of the lining-up in the queue by using an adjustment time set based on the attribute information as a waiting time in the case of the lining-up in the queue; and

outputting the estimated waiting time of the queue to an announcement device that announces the waiting time.

According to still another aspect of the present invention, a program storage medium stores a computer program causing a computer to perform:

acquiring, as attribute information, at least one type of information among content of behaviors, a type of a belonging, an expression, and information indicating whether a group is formed that are related to people lined up in a queue, from a captured image in which the people lined up in the queue are imaged;

estimating a time obtained by adjusting a standard waiting time in a case of the lining-up in the queue by using an adjustment time set based on the attribute information as a waiting time in the case of the lining-up in the queue; and

outputting the estimated waiting time of the queue to an announcement device that announces the waiting time.

### Advantageous Effects of Invention

According to the present invention, it is possible to improve estimation accuracy of a waiting time of a queue.

### BRIEF DESCRIPTION OF DRAWINGS

FIG. 1 is a diagram illustrating a configuration of a waiting time announcement system according to a first example embodiment of the present invention.

FIG. 2 is a block diagram illustrating a functional configuration of a waiting time estimation device included in the waiting time announcement system according to the first example embodiment.

FIG. 3 is a diagram illustrating a specific example of attribute information and an adjustment time.

FIG. 4 is a flowchart illustrating an exemplary operation of the waiting time estimation device according to the first example embodiment.

FIG. 5 is a diagram illustrating functions of a waiting time estimation device according to a second example embodiment of the present invention.

FIG. 6 is a block diagram illustrating a configuration of a waiting time announcement system according to a third example embodiment of the present invention.

FIG. 7 is a block diagram illustrating a functional configuration of a waiting time estimation device according to the third example embodiment.

FIG. 8 is a flowchart illustrating an exemplary operation of the waiting time estimation device according to the third example embodiment.

### EXAMPLE EMBODIMENT

Hereinafter, example embodiments of the present invention will be described with reference to the drawings.

### First Example Embodiment

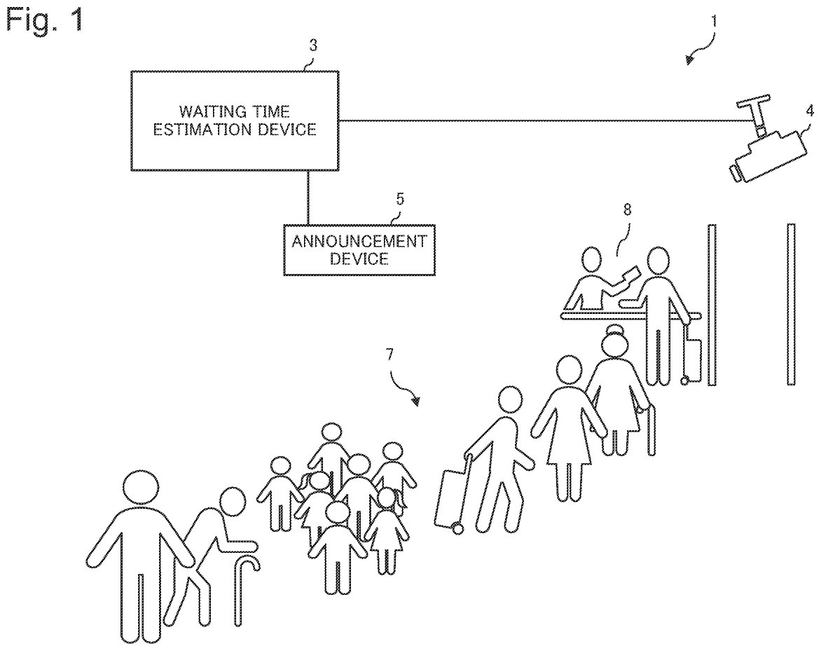

FIG. 1 is a diagram illustrating a configuration of a waiting time announcement system according to a first example embodiment of the present invention. A waiting time announcement system 1 according to the first example embodiment is a system that announces a waiting time when people are lined up in a queue 7 (when people join the end of the queue 7). In the first example embodiment, the queue 7 is assumed to be a queue formed by people lined up at an examination window 8 of an entrance examination gate (immigration) in an airport.

The waiting time announcement system 1 according to the first example embodiment includes a waiting time estimation device 3, an imaging device 4, and an announcement device 5. The imaging device 4 is, for example, a video camera, and has a function of generating a moving image by visible light and outputting an image (a captured image) obtained through imaging. In the first example embodiment, the imaging device 4 is an imaging device that images a queue formed at the examination window 8 of the entrance examination gate. When there is one examination window 8, the imaging device 4 is installed at a position at which the entire queue assumed to be formed at the examination window 8 can be imaged while taking a field of view of the imaging device 4 into consideration. When the plurality of examination windows 8 are arranged in parallel, the plurality of imaging devices 4 relevant to the plurality of examination windows 8 are each installed at a position at which the entire queue assumed to be formed at the relevant examination window 8 can be imaged. Alternatively, when the plurality of examination windows 8 are arranged in parallel, the lined examination windows 8 are divided into a plurality of sections and the plurality of imaging devices 4 relevant to the sections are installed at positions at which the imaging devices 4 can image the entire queue assumed to be formed at the examination windows 8 of the relevant sections. Alternatively, when a plurality of examination windows 8 are arranged in parallel, the imaging device 4 common to all the examination windows 8 is installed at a position at which the entire queue assumed to be formed at all the examination windows 8 can be imaged.

Further, in the first example embodiment, the imaging device 4 has a zooming function, a panning function and a tilting function to capture zoomed-in images of people lined up in the queue. It is assumed that zooming performance in the imaging device 4 has performance satisfying a requirement determined in consideration of processing related to a captured image performed by the waiting time estimation device 3. A movable range of a movable unit that enables the panning function and the tilting function in the imaging device 4 is a range in which an imaging range can be moved from the head of the queue to the assumed tail of the queue while people lined up in the queue are imaged in a predetermined zoomed-in state by the zooming function.

As described above, as the imaging operation of the imaging device 4, there are an entire imaging operation of imaging the entire queue and an individual imaging operation of zooming in on and imaging people lined up in the queue while moving the imaging range from the head to the rear of the queue. The imaging operation of the imaging device 4 is controlled by, for example, the waiting time estimation device 3. As information used to control the imaging operation of the imaging device 4, for example, there is information regarding a length of a period in which the entire imaging operation is performed and a length of a period in which the individual imaging operation is performed. As the information used when the imaging operation of the imaging device 4 is controlled, there is also information regarding the number of times movement imaging of moving the imaging range from the head to the tail of the queue is repeated in a period in which the individual imaging operation is performed. The information used for the imaging control is information that is appropriately set in consideration of processing related to an image captured by the waiting time estimation device 3. As a control scheme of the imaging operation of the imaging device 4, there are various schemes. Here, any scheme may be adopted and description thereof will be omitted.

In the above-described example, the imaging device 4 has a function of imaging the entire queue and a function of zooming in on and imaging people lined up in the queue. On the other hand, for example, there are cases in which it is difficult for one imaging device to have both of these functions depending on the performance of the device and the assumed length of the queue. In this case, the waiting time announcement system 1 may include two types of imaging devices, an imaging device that images the entire queue and an imaging device that zooms in on and images people lined up in the queue. In this case, these two types of imaging devices are described as the imaging device 4 without distinguishing the imaging devices from each other.

The imaging device 4 is connected to the waiting time estimation device 3, and an image captured by the imaging device 4 is output to the waiting time estimation device 3 in real time. The captured image output from the imaging device 4 to the waiting time estimation device 3 is associated with, for example, information regarding an imaging time, information indicating an imaging position (such as identification information for identifying the imaging device 4), and information indicating whether the imaging is performed through the whole imaging operation or the individual imaging operation.

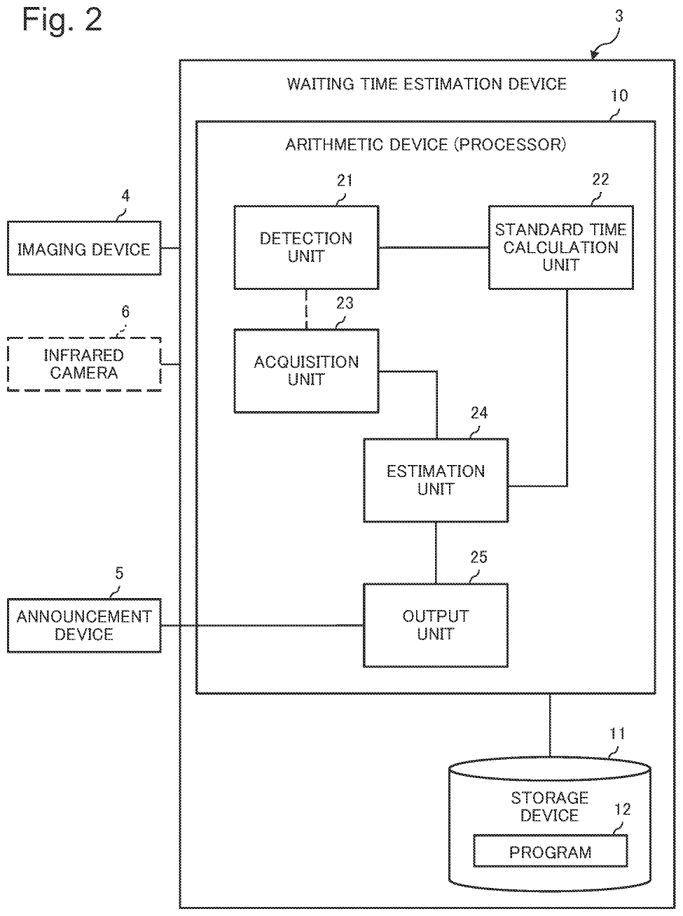

The waiting time estimation device 3 is configured as, for example, a computer device (server) and has a function of estimating a waiting time of a queue using a captured image when the captured image is received from the imaging device 4. FIG. 2 is a block diagram illustrating a functional configuration of the waiting time estimation device 3. The waiting time estimation device 3 includes an arithmetic device 10 and a storage device 11. The storage device 11 is a storage medium that stores data and a computer program (hereinafter also referred to as a program) 12. There are various types of storage media and the storage device 11 may be configured as any storage medium. The waiting time estimation device 3 may include a plurality of types of storage media. In this case, the plurality of types of storage media are collectively represented as the storage device 11. Description of the configuration and an operation of the storage device 11 will be omitted.

The arithmetic device 10 includes, for example, a processor such as a central processing unit (CPU) or a graphics processing unit (GPU). The processor can have various functions based on a program by reading and executing the program stored in the storage device 11. For example, in the first example embodiment, the arithmetic device 10 includes functional units such as a detection unit 21, a standard time calculation unit 22, an acquisition unit 23, an estimation unit 24, and an output unit 25.

The detection unit 21 has a function of detecting a queue and the number of people lined up in the queue or a value corresponding to the number of people as the number of detected people from a captured image in which the entire queue is captured. When a plurality of examination windows 8 are arranged in parallel and a plurality of queues are formed, the detection unit 21 detects each of the queues and the number of detected people in each of the queues. Examples of the value corresponding to the number of people as the number of detected people include an occupation area (or the number of pixels) occupied by the queue in the image.

The above-described detection operation of the detection unit 21 is performed at preset time intervals. A scheme of detecting a queue from a captured image and a scheme of detecting the number of detected people (a value according to the number of people or the number of people) lined up in the queue are not limited here. The detection schemes are appropriately set in consideration of various factors such as a place where a queue is formed (a background shown in a captured image) and a resolution of the captured image, and the description thereof will be omitted.

For example, information of identifying the captured image in which the information is detected (image identification information (for example, imaging time information or a frame image number)) and information for identifying the queue (queue identification information) are associated with the information regarding the number of detected people in the queue detected by the detection unit 21. As the information for identifying the queue, for example, information for identifying the examination window 8 that is a source of the queue is used.

The standard time calculation unit 22 has a function of calculating, as a standard waiting time, a standard waiting time in the case of the lining-up in the queue (the case of joining the end of the queue) by using the number of people detected by the detection unit 21 and standard time data stored in advance in the storage device 11. The standard time data is data indicating the standard waiting time when the number of detected people are lined up in the queue and is data in which the number of detected people and the standard waiting time are associated with each other. For example, when the number of people lined up in the queue (the number of detected people) is 8 and the standard waiting time is 32 minutes, the standard time data includes data in which the number of detected people “8” (or a value corresponding to eight people) and the standard waiting time “32 minutes” are associated with each other. The standard time data is, for example, data generated based on a large amount of data of actual waiting times when the number of detected people are lined up in the queue.

Information regarding the number of detected people used for the calculation, that is, the image identification information and the queue identification information is associated with the information regarding the standard waiting time calculated by the standard time calculation unit 22 is associated with information regarding the number of detected people used for the calculation, that is, the image identification information and the queue identification information.

The acquisition unit 23 has a function of detecting people lined up in the queue from a captured image (in the first example embodiment, an image captured through the individual imaging operation of the imaging device 4) in which the people lined up in the queue are captured. Information for identifying people detected by this function is associated with information for identifying a captured image in which the information is detected (image identification information) and identification information regarding the queue in which the detected people are lined up (queue identification information).

Further, the acquisition unit 23 has a function of acquiring attribute information regarding people lined up in the queue. Here, the attribute information is information indicating a feature related to a time required for reception at the examination window 8 among the information indicating the features of people lined up in the queue. For example, since an age is assumed to be related to a time required for the reception at the examination window 8 with the time required for the reception at the examination window 8 tending to increase as people age, the age is considered to be one type of the attribute information. In addition, when a person is looking around with an anxious expression, the person is considered to be inexperienced with an entrance examination. Thus, such an inexperienced person will tend to take a long time in the entrance examination at the examination window 8. As a result, since it is assumed that content of a behavior and the expression are related to a time required for reception at the examination window 8, the content of the behavior and the expression are considered as attribute information.

In addition, since it is assumed that belongings of people lined up in the queue are related to a time required for reception at the examination window 8, with people carrying canes or strollers tending to require a longer time for reception at the examination window 8, the belongings are also considered to be one type of the attribute information. Further, in the case of a group such as a group of family or a group on a school trip, a time per person required for reception at the examination window 8 tends to be short. Thus, information indicating whether people lined up in the queue are people forming a group is also considered to be one type of the attribute information.

As described above, a plurality of types of information are considered as the attribute information acquired by the acquisition unit 23 from an image captured by the imaging device 4, and appropriate information related to progress of the arrangement order from the head of the queue is set as the attribute information. However, the attribute information here includes at least one type of information among content of behaviors of people lined up in the queue, types of belongings, expressions, and the information indicating whether the people form the groups. Further, the attribute information may not necessarily be acquired for all the people lined up in the queue.

A scheme in which the acquisition unit 23 acquires the attribute information from a captured image, such as a scheme of detecting facial expressions of people from the captured image, a scheme of detecting belonging of people, a scheme of detecting content of behaviors of people, and a scheme of determining whether peoples form a group, is not limited here, and the description thereof will be omitted.

The attribute information acquired by the acquisition unit 23 is associated with information for identifying people relevant to the attribute information. That is, the attribute information acquired by the acquisition unit 23 is associated with the information for identifying a person in the data in which the image identification information, the information for identifying a queue (information for identifying the examination window 8), and the information for identifying people lined up in the queue are associated.

Further, an infrared camera 6 indicated by a dotted line in FIG. 2 may be installed, for example, similarly to the imaging device 4. The acquisition unit 23 may also have a function of acquiring attribute information of people lined up in the queue from an image captured by the infrared camera 6. That is, the infrared camera 6 has a function of imaging people lined up in the queue of which waiting times are to be estimated with infrared rays and outputting an infrared image as a captured image. The infrared image from the infrared camera 6 includes information regarding heat generated by people. The infrared camera 6 is connected to the waiting time estimation device 3, and an infrared image from the infrared camera 6 is output to the waiting time estimation device 3.

As described above, when the waiting time estimation device 3 receives the infrared image, the acquisition unit 23 has a function of detecting people who have fever equal to or greater than a predetermined body temperature (for example, 37.5 degrees) among the people shown in the infrared image. A scheme of detecting such people who are feverish from the infrared image using, for example, a frequency of the infrared light is not limited, and description thereof will be omitted here.

The acquisition unit 23 has a function of, when people who are feverish are detected, as described above, acquiring information indicating that someone is feverish as attribute information.

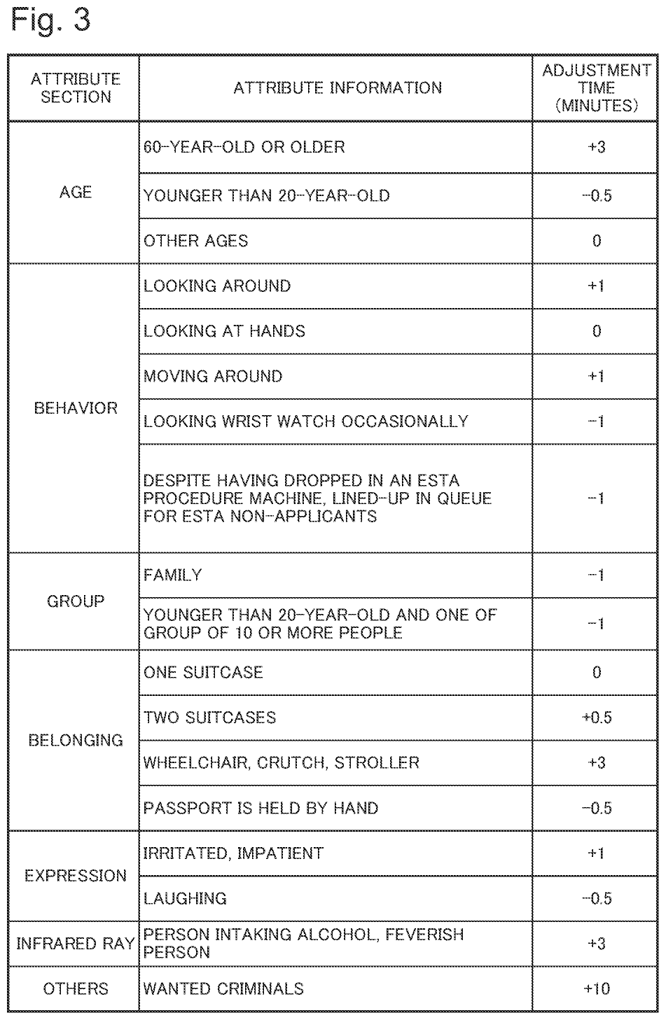

FIG. 3 illustrates a specific example of the attribute information acquired by the acquisition unit 23. The attribute information “despite having dropped in an electronic system for travel authorization (ESTA) procedure machine, lined-up in the queue for ESTA non-applicants” in FIG. 3 is a specific example of attribute information related to the U.S. entrance examination gate. Further, the attribute information “wanted criminals” is information indicating wanted criminals. When the attribute information is acquired, the waiting time estimation device 3 has, for example, a function of periodically acquiring data of face photographs of the wanted criminals from a police department and updating the data. Furthermore, the acquisition unit 23 has a function of determining whether the people lined up in the queue are the wanted criminals by extracting the features of the people lined up in the queue and matching the extracted features of the face with the features of the face extracted from the face photograph of the wanted criminals. Furthermore, the acquisition unit 23 has a function of not only associating the attribute information “wanted criminals” with the identification information of the people who have been detected as the wanted criminals but also notifying a predetermined notification device of the detection of the wanted criminals when the wanted criminals have been detected. As the notification device, an example in which a monitoring device (a desktop computer device, a mobile terminal, or the like) used by a monitoring surveillance staff in the airport functions as the notification device can be given.

The acquisition operation of the acquisition unit 23 may have a pause period. For example, when it is determined that there is hardly any queue or the queue is short by using the information of a detection result by the detection unit 21, the acquisition unit 23 may pause the acquisition operation. In this way, by pausing the acquisition unit 23, a load on the waiting time estimation device (server) 3 can be reduced.

The estimation unit 24 has a function of estimating, as the waiting time in the case of the lining-up in the queue, a time obtained from the standard waiting time in the case of the lining-up in the queue by using an adjustment time calculated based on the attribute information. For example, when the acquisition unit 23 acquires the attribute information from the captured image, the estimation unit 24 collates the attribute information with adjustment time data in which the attribute information as illustrated in FIG. 3 and the information regarding the adjustment time are associated. That is, it is assumed that a time required for reception at the examination window 8 differs depending on attributes of people lined up in the queue. Therefore, to improve estimation accuracy of the waiting time of the queue, it is preferable to change the standard waiting time using a time according to the attributes of the people lined up in the queue. In consideration of this, here, the standard waiting time is assumed to be changed using the time according to the attribute of the people lined up in the queue. The adjustment time is a time used to change the standard waiting time and is a time set in advance according to the attribute of the people lined up in the queue.

The estimation unit 24 acquires information regarding the adjustment time associated with the attribute information by collating the attribute information with the adjustment time data. When there are a plurality of types of attribute information related to the same queue, the estimation unit 24 acquires the information regarding the adjustment time associated with each type of attribute information from the adjustment time data. The estimation unit 24 acquires information regarding the standard waiting time by the detection unit 21 and the standard time calculation unit 22 using one of the captured images in which the entire queue imaged within a predetermined time range including imaging times of the captured images used to acquire the attribute information is imaged.

Further, the estimation unit 24 estimates a time obtained by adding the adjustment time to the acquired standard waiting time as a waiting time of the queue. Specifically, for example, when “32 minutes” is calculated as the standard waiting time and “−1 minute” is acquired as the adjustment time, the estimation unit 24 estimates “31 minutes” obtained by adding the adjustment time of“−1 minute” to the standard waiting time of “32 minutes” as the waiting time of the queue. When there are a plurality of adjustment times related to the same queue, all the adjustment times are added to the standard waiting time.

The output unit 25 has a function of outputting information regarding the waiting time of the queue estimated by the estimation unit 24 to the announcement device 5.

The announcement device 5 is a device that announces the waiting time of the queue estimated by the waiting time estimation device 3. The announcement device 5 is, for example, a display device, and is installed at a position at which people lined up in the queue can be seen easily. When it is assumed that a plurality of queues are formed, the plurality of announcement devices 5 relevant to each of the queues may be installed or the announcement device 5 that collectively displays information regarding the waiting times of the queues may be installed. For example, a speaker that audibly announces the information regarding the waiting time of the queue may also be installed as the announcement device 5.

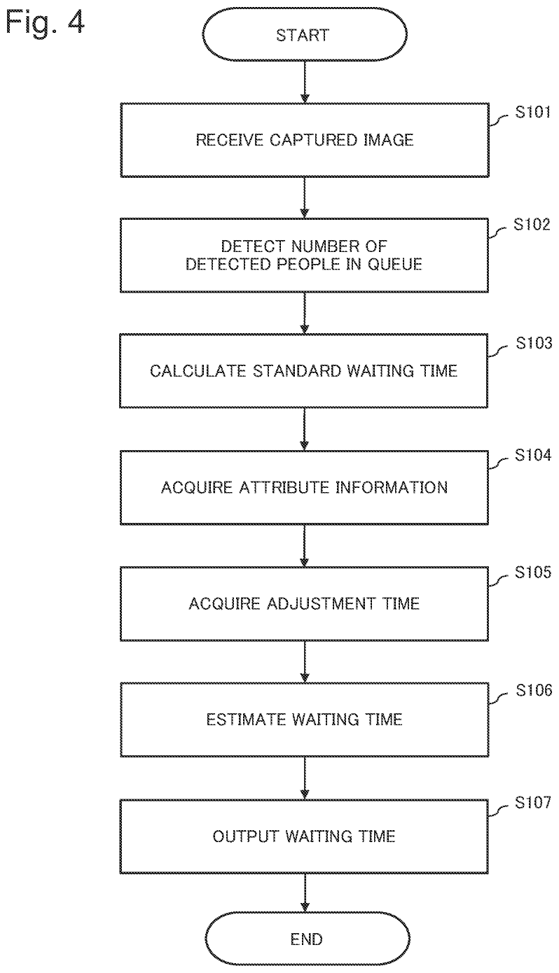

Hereinafter, an example of an operation related to estimation and notification of a waiting time of a queue in the waiting time estimation device 3 will be described with reference to the flowchart of FIG. 4.

For example, the waiting time estimation device 3 receives the captured image through the entire imaging operation from the imaging device 4 (step S101). The detection unit 21 of the arithmetic device 10 detects the number of people lined up in the queue or a value according to the number of people from the captured image as the number of detected people (step S102). Then, the standard time calculation unit 22 calculates the standard waiting time of a queue relevant to the number of detected people (step S103).

On the other hand, when the waiting time estimation device 3 receives the captured image of the individual imaging operation from the imaging device 4 after the captured image of the entire imaging operation, the acquisition unit 23 of the arithmetic device 10 acquires the attribute information regarding the people lined up in the queue (step S104). Further, the estimation unit 24 acquires information regarding the adjustment time associated with the attribute information from the adjustment time data (step S105). Furthermore, the estimation unit 24 adds the acquired adjustment time and the standard waiting time of the queue calculated by the standard time calculation unit 22 to estimate the time obtained by adjusting the standard waiting time as the waiting time of the queue (step S106).

Then, output unit 25 outputs the estimated waiting time to the announcement device 5 (step S107). The series of operations from step S101 to step S107 as described above is repeatedly executed at preset timing (for example, every preset time interval).

The waiting time announcement system 1 and the waiting time estimation device 3 according to the first example embodiment have the above-described configurations. That is, the waiting time estimation device 3 adjusts the standard waiting time using the number of people lined up in the queue (the number of people) or the number of detected people which is a value according to the number of people lined up in the queue with an adjustment time according to the attribute information of the people lined up in the queue and outputs the adjusted time as the waiting time of the queue. As the attribute information of the people used for adjusting the waiting time, at least one type of information among content of a behavior, a type of a belonging, an expression, and information indicating whether a group is formed is included. Whether the content of these behavior, the type of a belonging, a facial expression, or a group is formed is formed are information effective for estimating the speed of movement of a person related to the matter that is the basis of the queue. When such information is acquired as the attribute information and the standard waiting time is adjusted with the adjustment time according to the attribute information to estimate a waiting time, estimation accuracy of the waiting time can be improved more than when the waiting time is simply estimated based on the number of detected people in the queue.

### Second Example Embodiment

Hereinafter, a second example embodiment of the present invention will be described. In description of the second example embodiment, the same reference numerals are given to the same components as the components included in the waiting time announcement system and the waiting time estimation device of according to first example embodiment, and repeated description of the common portions will be omitted.

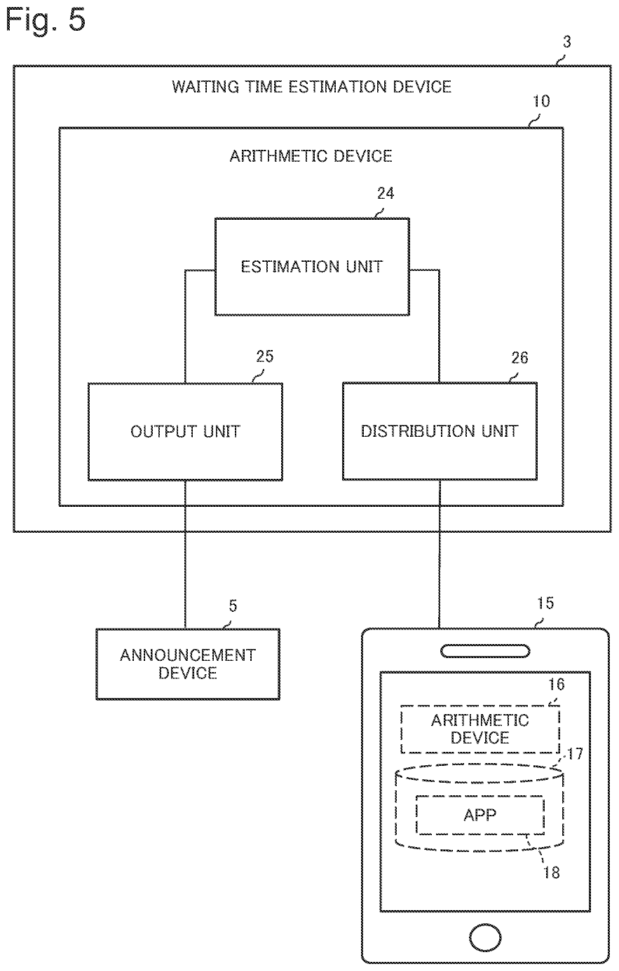

A waiting time announcement system according to the second example embodiment has a configuration capable of also notifying a mobile terminal of information regarding a waiting time of a queue in addition to the configuration of the waiting time announcement system 1 of the first example embodiment. That is, in the waiting time announcement system 1 according to the second example embodiment, as illustrated in FIG. 5, the arithmetic device 10 of the waiting time estimation device 3 includes a distribution unit 26. In FIG. 5, in the waiting time estimation device 3, the storage device 11, the detection unit 21, and the standard time calculation unit 22 and the acquisition unit 23 of the arithmetic device 10 illustrated in FIG. 2 are not illustrated.

In the second example embodiment, as in the first example embodiment, information regarding the waiting time of the queue by the estimation unit 24 is output from the output unit 25 to the announcement device 5.

On the other hand, the distribution unit 26 has a function of distributing information regarding the waiting time of the queue by the estimation unit 24 toward the mobile terminal 15. The mobile terminal 15 is, for example, a terminal carried by a support staff who maintains a queue and includes a display device and a speaker that announces information.

The distribution unit 26 has a function of distributing an application (app) 18 that provides the mobile terminal 15 with a function of receiving information regarding the waiting time of such a queue from the waiting time estimation device 3 and outputting the received information to a display screen or the like. The mobile terminal 15 to which the information is distributed from the distribution unit 26 is a terminal in which the app 18 from the distribution unit 26 is installed. That is, the mobile terminal 15 includes the arithmetic device 16 including a processor such as a CPU and the storage device 17, and the arithmetic device 16 executes the app 18 stored in the storage device 17 to receive the information regarding the waiting time of the queue from the distribution unit 26 and announces the received information.

Since the waiting time announcement system 1 according to the second example embodiment has the same configuration as the waiting time announcement system 1 according to the first example embodiment, it is possible to obtain the same advantageous effects as those of the waiting time announcement system 1 according to the first example embodiment. In addition, the waiting time announcement system 1 according to the second example embodiment is configured to also deliver the information regarding the waiting time in a queue to the mobile terminal 15. Therefore, the mobile terminal 15 can also announce the information regarding the waiting time in the queue. Thus, it is possible to improve convenience of the system.

In the waiting time announcement system 1 according to the second example embodiment, at a place where a plurality of queues are formed, a support staff who maintains the queues can know a waiting time of each queue using the mobile terminal 15. Accordingly, it is easy for the support staff to guide people lined up in the queue or people lined up in the queue in such a manner that the waiting times of the plurality of queues are similar. When the waiting times of a plurality of queues are similar, it is assumed that dissatisfaction of people lined up in the queues is alleviated more than when the waiting times of the plurality of queues vary.

In the second example embodiment, the distribution unit 26 distributes information regarding the waiting time of the queue by the estimation unit 24 to the mobile terminal 15. In addition to this, the waiting time estimation device 3 may further include a configuration that causes the mobile terminal 15 to announce that people requiring support are lined up in the queue. That is, here, as the attribute information representing people lined up in the queue, attribute information (for example, elderly people or belongings which are wheelchairs or canes.) indicating features of people assumed to require support is set as the attribute information of the support requirement. When the acquisition unit 23 acquires the attribute information of the support requirement as the attribute information of people lined up in the queue, the attribute information of the support requirement, information for identifying people relevant to the attribute information, and information for identifying the queue are associated. The distribution unit 26 outputs the associated information to the mobile terminal 15. In the mobile terminal 15, the information regarding people requiring support is announced by the arithmetic device 16 based on the app 18.

In the first and second example embodiments, the configurations and the operations of the waiting time announcement system and the waiting time estimation device have been described on the assumption that the queue is a queue formed at the examination window of the entrance examination gate. However, the queue is not limited to a queue formed at the examination window of the entrance examination gate. That is, the waiting time announcement system and the waiting time estimation device according to the first and second example embodiments can also be applied to estimation and announcement of the waiting time in a queue other than the queue formed at the examination window of the entrance examination gate. For example, when a device that calculates the standard waiting time in the case of the lining-up in the queue based on the number of people in the queue counted by a support staff or the like who maintains the queue is separate from the waiting time estimation device, the waiting time estimation device may acquire the standard waiting time from the device. In this case, the waiting time estimation device may not include the detection unit and the standard time calculation unit. The waiting time estimation device estimates the waiting time of the queue by adjusting the information regarding the acquired standard waiting time using the attribute information acquired from a captured image by the acquisition unit.

In the first and second example embodiments, the imaging device 4 is a device that is installed to be able to image the entire queue assumed to be formed at the examination window 8 and has a zooming function or the like to zoom in on and image people lined up in the queue. Instead of this, for example, the plurality of imaging devices 4 may be installed to image different portions in one queue assumed to be formed at the examination window 8 and the plurality of imaging devices 4 may image the entire queue. In this case, the waiting time estimation device 3 has a function of obtaining a captured image in which the entire queue is imaged by combining captured images output from the plurality of imaging devices 4 imaging different positions in one queue. The detection unit 21 detects a queue and the number of people lined up in the queue or a value relevant to the number of people as the number of detected people from the captured image of the entire queue obtained by combining the captured images. Further, the acquisition unit 23 detects people lined up in the queue from the combined captured image and further acquires the attribute information of the detected people. As described above, in a configuration in which different portions in one queue are imaged by the plurality of imaging devices 4, the imaging devices 4 can clearly image people to the extent that attribute information such as expressions of the people lined up in the queue can be acquired without a zooming function. Such a configuration is also effective when it is assumed that the entire queue cannot be imaged with one imaging device 4.

### Third Example Embodiment

Hereinafter, a third example embodiment according to the present invention will be described.

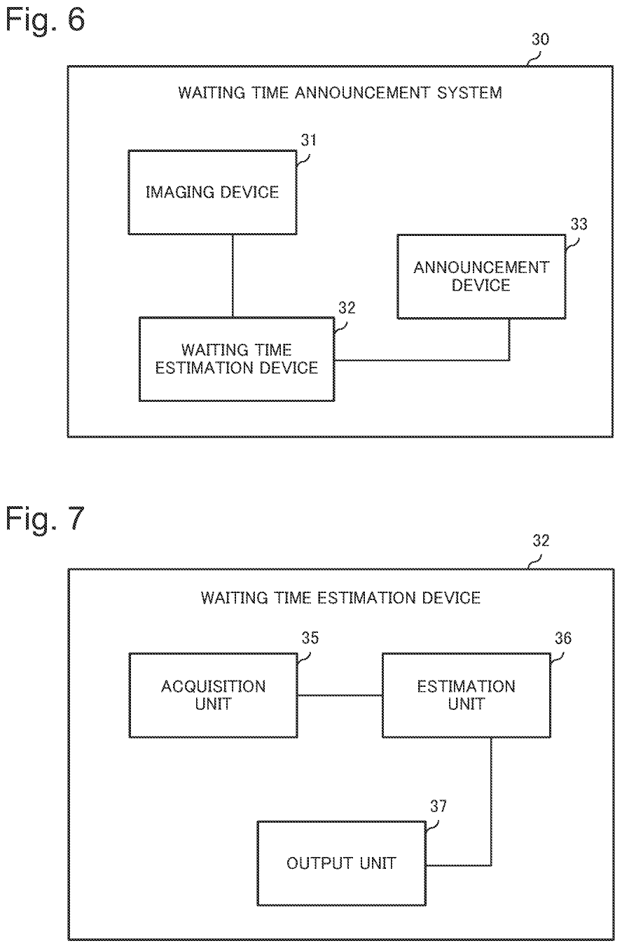

FIG. 6 is a block diagram illustrating a configuration of a waiting time announcement system according to the third example embodiment. A waiting time announcement system 30 is a system that estimates a waiting time in the case of the lining-up in the queue (the case of joining the end of the queue) and announces the estimated waiting time. The waiting time announcement system 30 includes an imaging device 31, a waiting time estimation device 32, and an announcement device 33.

The imaging device 31 is installed at a position at which people lined up in the queue of which a waiting time is to be estimated can be imaged, and has a function of imaging the people lined up in the queue and outputting a captured image in which the people are imaged. A video camera can be exemplified as a specific example of the imaging device 31.

The waiting time estimation device 32 is configured by, for example, a computer device. FIG. 7 is a block diagram illustrating an example of a functional configuration of the waiting time estimation device 32. The waiting time estimation device 32 includes an acquisition unit 35, an estimation unit 36, and an output unit 37 as functional units.

The acquisition unit 35 has a function of acquiring, as attribute information, at least one type of information among content of behaviors of the people lined up in the queue, types of belongings, expressions, and information indicating whether the people form the group from the captured image received from the imaging device 31.

The estimation unit 36 has a function of estimating, as the waiting time in the lining-up in the queue, a time obtained by adjusting the standard waiting time in the case of the lining-up in the queue using an adjustment time set based on the attribute information.

The output unit 37 has a function of outputting the estimated waiting time of the queue to the announcement device 33.

Announcement device 33 is a device that announces information about a waiting time of a queue estimated by waiting time estimation device 32. The announcement device 33 is installed at, for example, a position at which an announcement can be made to people who are about to line up in the queue. The announcement device 33 includes, for example, a display device that visually announces the waiting time or a speaker that audibly announces the waiting time.

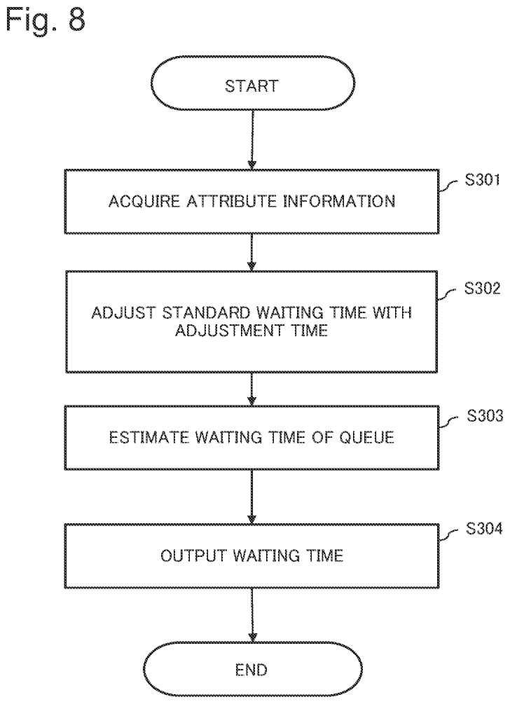

The waiting time announcement system and the waiting time estimation device according to the third example embodiment have the above-described configurations. Next, an example of an operation related to estimation and output of the waiting time in the waiting time estimation device 32 will be described with reference to FIG. 8.

For example, when the waiting time estimation device 32 receives the captured image in which people lined up in the queue are imaged from the imaging device 31, the acquisition unit 35 acquires the attribute information regarding the people lined up in the queue from the captured image (step S301). The attribute information includes at least one type of information among the content of the behavior of people lined up in the queue, the types of belongings, the expressions, and the information indicating whether the people are included in a group.

The estimation unit 36 adjusts the standard waiting time in the case of the lining-up in the queue using the adjustment time set based on the attribute information (step S302). The estimation unit 36 estimates the adjusted time as the waiting time of the queue (step S303). The output unit 37 outputs information regarding the estimated waiting time to the announcement device 33 (step S304).

As in the first and second example embodiments, the waiting time announcement system 30 and the waiting time estimation device 32 according to the third example embodiment adjusts the standard waiting time using the adjustment time set based on the attribute information regarding people lined up in the queue and estimates the adjusted time as the waiting time of the queue. Accordingly, the waiting time announcement system 30 and the waiting time estimation device 32 according to the third example embodiment can improve the estimation accuracy of the waiting time of the queue as in the first and second example embodiments.

The present invention has been described above giving the above-described example embodiments as typical examples. However, the present invention is not limited to the above-described example embodiments. That is, in the present invention, various aspects that can be understood by those skilled in the art can be applied within the scope of the present invention.

### REFERENCE SIGNS LIST

1, 30 waiting time announcement system
3, 32 waiting time estimation device
4, 31 imaging device
5, 33 announcement device
21 detection unit
22 standard time calculation unit
23, 35 acquisition unit
24, 36 estimation unit
25, 37 output unit

What is claimed is:

1. A waiting time estimation device comprising,
at least one processor configured to:
acquire, as attribute information, at least one type of information among content of behaviors, a type of a belonging, an expression, and information indicating whether a group is formed that are related to people lined up in a queue, from a captured image in which the people lined up in the queue are imaged;
estimate a time obtained by adjusting a standard waiting time in a case of the lining-up in the queue by using an adjustment time set based on the attribute information as a waiting time in the case of the lining-up in the queue; and
output the estimated waiting time of the queue to an announcement device that announces the waiting time.

2. The waiting time estimation device according to claim 1, wherein the at least one processor is further configured to acquire information indicating that someone in the queue has a higher fever than a predetermined body temperature as the attribute information from an infrared image in which the people lined up in the queue are imaged.

3. The waiting time estimation device according to claim 1, wherein the at least one processor is further configured to:
detect the number of people lined up in the queue or a value corresponding to the number of people as the number of detected people from a captured image in which the entire queue is captured; and
calculate the standard waiting time based on the number of detected people.

4. The waiting time estimation device according to claim 1, wherein the at least one processor is further configured to output the estimated waiting time to an announcement device that announces the waiting time.

5. A waiting time announcement system comprising:
the waiting time estimation device according to claim 1;
an imaging device configured to provide the captured image to the waiting time estimation device; and
an announcement device configured to announce the waiting time estimated by the waiting time estimation device.

6. The waiting time announcement system according to claim 5,
wherein the announcement device also includes a mobile terminal that has a function of announcing the waiting time.

7. A waiting time estimation method comprising:
by a computer,
acquiring, as attribute information, at least one type of information among content of behaviors, a type of a belonging, an expression, and information indicating whether a group is formed that are related to people lined up in a queue, from a captured image in which the people lined up in the queue are imaged;
estimating a time obtained by adjusting a standard waiting time in a case of the lining-up in the queue by using an adjustment time set based on the attribute information as a waiting time in the case of the lining-up in the queue; and
outputting the estimated waiting time of the queue to an announcement device that announces the waiting time.

8. A non-transitory program storage medium that stores a computer program causing a computer to perform:
acquiring, as attribute information, at least one type of information among content of behaviors, a type of a belonging, an expression, and information indicating whether a group is formed that are related to people lined up in a queue, from a captured image in which the people lined up in the queue are imaged;
estimating a time obtained by adjusting a standard waiting time in a case of the lining-up in the queue by using an adjustment time set based on the attribute information as a waiting time in the case of the lining-up in the queue; and
outputting the estimated waiting time of the queue to an announcement device that announces the waiting time.
